(19) United States
(12) Patent Application Publication
(10) Pub. No.: US 2006/0019125 A1
(43) Pub. Date: Jan. 26, 2006

(54) Magnetic recording medium and production method thereof as well as magnetic disc device

(75) Inventor: Takashi Gouke, Higashine (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/992,996

(22) Filed: Nov. 19, 2004

(30) Foreign Application Priority Data
Jul. 7, 2004 (JP) 2004-200492(PAT.

(51) Int. Cl. G11B 5/66

(52) U.S. Cl. 428/832.1; 428/832.2

(57) ABSTRACT

A magnetic recording medium comprises a non-magnetic substrate having deposited thereon, in sequence, at least one underlayer formed of Cr or a Cr-based alloy, at least one intermediate layer formed of a Co-based alloy and at least one magnetic recording layer formed of a CoCr-based alloy, and the underlayer and/or the intermediate layer is a thin film formed by a sputtering method in the presence of krypton gas and/or xenon gas. A production method of the magnetic recording medium and a magnetic disc device using the magnetic recording medium are also disclosed.

### CROSS-REFERENCE TO RELATED APPLICATIONS

This application is based upon and claims the priority of Japanese Patent Application No. 2004-200492, filed on Jul. 7, 2004, the contents being incorporated herein by reference.

### BACKGROUND OF THE INVENTION

1. Field of the Invention

This invention relates to a magnetic recording medium, used for a disc device, and the like, in a computer, and capable of high density recording, its production method and a magnetic recording/reproduction apparatus (hereinafter called “magnetic disc device”) using the magnetic recording medium of the invention.

2. Description of the Related Art

Magnetic disc devices have widely been used as external recording apparatuses in information processing units such as computers. A magnetic disc device can write and read information in a magnetic recording medium by moving a magnetic head over a magnetic recording medium (magnetic disc).

The conventionally used prior art magnetic recording medium comprises a non-magnetic substrate and an underlayer, a magnetic recording layer (also called a “magnetic layer”), a protective layer and a lubricant layer that are deposited, in this order, on the substrate, as is well-known in the art. In such a magnetic recording medium, the substrate is an aluminum substrate, for example, and has a NiP layer applied by plating on its surface. The surface of the substrate is super-finished. Super-finishing is for planarizing the surface of the substrate. The underlayer is generally formed of Cr, as a non-magnetic metal, or an alloy. The Cr-based alloy is a CrMo alloy, for example. The magnetic recording layer is generally formed of a CoCr-based alloy as a ferromagnetic metal. Examples of the CoCr-based alloy include CoCrTa, CoCrPt, CoCrPtBi and CoCrPtTaNb. The protective layer is disposed on the magnetic recording layer to protect the magnetic recording layer from damage resulting from impact of the magnetic head. The protective layer is formed of various carbon materials such as amorphous carbon. The protective layer is generally called a “carbon protective layer”. The carbon protective layer is impregnated with a liquid lubricant such as a fluorocarbon type liquid lubricant to form a lubricant layer in order to accomplish smooth floating of the head over the magnetic recording medium.

As an information processing technology has advanced (application to AV equipments, etc) in recent years, a larger recording capacity has been required for the magnetic disc devices. To produce a magnetic disc device having a larger recording capacity, a recording bit size must be reduced and research has been done regarding the magnetic recording medium, too.

W50 (isolated reproduction wave half value width) is known as an index for the miniaturization of the recording bit size. It has been reported that the smaller the W50 value, the more suitable, generally, the recording medium is for a high recording density.

It is generally known that the W50 value is expressed by the following formula:
W50=2sqrt{(g/2)²+(d+a)²}

In the formula given above, g is a gap length of a magneto-resistance element, d is a magnetic spacing width and a is a magnetization transition width.

It can be appreciated from this formula that in order to decrease the W50 value, that is, to accomplish the high recording density, it is necessary to decrease the gap length of the magneto-resistance element and to reduce the magnetic spacing between the magneto-resistance element and the recording layer of the magnetic recording medium.

To reduce the magnetization transition width of the magnetic recording medium, a method that makes the crystal grains of the magnetic recording layer small, by forming a thin film of each layer constituting the magnetic recording medium, is effective. However, because the volume of recording magnetization per bit decreases with miniaturization of the crystal grains, the problem of recording destruction by thermal disturbance occurs (cf. Abarra et al., Synthetic Ferromagnetic Media, IEEE Trans. Magn. Vol. 37, No. 4, 1426-1431(2001), for example). To suppress this thermal disturbance, it is effective to increase a Pt (platinum) content in the CoCr-based alloy forming the magnetic recording layer, specifically a CoCrPt (B or Ta)-based alloy to thereby improve a coercive force (Hc). It is known, however, that the increase of the Pt content invites amplification of the medium noise because the interaction among the crystal grains increases in the magnetic recording layer.

For these reasons, it has been difficult, in accordance with the prior art technology, to simultaneously achieve low noise, by miniaturization of the crystal grains of the recording layer of the magnetic recording medium, and an improvement in the thermal disturbance resistance.

### SUMMARY OF THE INVENTION

It is an object of the invention to provide a magnetic recording medium that solves the problems of the prior art technology described above, provides a high recording density of a magnetic recording medium by making the crystal grains of the magnetic recording layer small, imparts high coercive force to the magnetic recording layer without deteriorating noise performance of the medium, and can accomplish the improvement of the thermal disturbance resistance or, in other words, can provide both low noise and high thermal disturbance resistance.

It is another object of the invention to provide a production method of a magnetic recording medium that can provide both low noise and thermal disturbance resistance.

It is still another object of the invention to provide a magnetic disc device that accomplishes a large recording capacity by miniaturizing a recording bit size in a medium.

The above and other objects of the invention will be readily understood from the following detailed description.

The inventor of this application has conducted intensive studies to accomplish the objects described above and, in the course of the studies, has specifically reached a method comprising the steps of forming at least one underlayer of Cr or a Cr-based alloy on a non-magnetic substrate such as glass or aluminum, further forming at least one intermediate layer formed of a Co-based alloy and forming at least one layer of a CoCr-based alloy as a magnetic layer. In the formation of these thin films, the inventor has found it effective to use a krypton (Kr) gas or a xenon (Xe) gas in place of an argon (Ar) gas that has generally been used as a film forming gas, and has completed the present invention. The Kr gas and the Xe gas have a large atomic radius and provide high film formation efficiency. The crystal lattice gaps of the Cr underlayer can be expanded with increase of the size of the atomic radius and, as a result, miss-matching mistake of the crystal lattice gap between the underlayer and the magnetic recording layer can be improved. These gases may be used as a mixture, as necessary.

According to one aspect of the invention, there is provided a magnetic recording medium comprising a non-magnetic substrate having deposited thereon, in sequence, at least one underlayer formed of Cr or a Cr-based alloy, at least one intermediate layer formed of a Co-based alloy and at least one magnetic recording layer formed of a CoCr-based alloy, wherein the underlayer and/or the intermediate layer is a thin film formed, by a sputtering method, in the presence of a krypton gas and/or a xenon gas.

The magnetic recording medium according to the present invention can increase a coercive force without increasing a Pt content in the magnetic recording layer. Therefore, a magnetic recording medium that is not easily affected by thermal disturbance can be produced without deteriorating noise performance of the medium even when the crystal grains of the magnetic recording layer are rendered small.

According to another aspect of the invention, there is provided a method of producing a magnetic recording medium comprising a non-magnetic substrate having applied thereon a magnetic recording layer, comprising the step of depositing, in sequence, at least one underlayer formed of Cr or a Cr-based alloy, at least one intermediate layer formed of a Co-based alloy and at least one magnetic recording layer formed of a CoCr-based alloy onto the non magnetic substrate; in which method the underlayer and/or the intermediate layer is/are formed by a sputtering method in the presence of a krypton gas and/or a xenon gas.

According to still another aspect of the invention, there is provided a magnetic disc device having a recording head for recording information and a reproduction head for reproducing information in a magnetic recording medium, wherein the magnetic recording medium is the magnetic recording medium according to the invention.

According to the invention, it becomes possible to provide a high recording density by making the crystal grains of a magnetic recording layer small, as will be readily understood from the following explanation. Because coercive force can be increased without increasing a Pt content in the magnetic recording layer, the invention can provide a magnetic recording medium not easily susceptible to thermal disturbance even when the crystal grains of the magnetic recording layer are rendered fine.

The invention can provide a production method of a magnetic recording medium that can provide low noise and thermal disturbance resistance and can provide high density recording.

The invention can further provide a magnetic disc device providing a higher recording capacity by reducing a recording bit size in a medium.

### BRIEF DESCRIPTION OF THE DRAWINGS

FIG. 1 is a cross-sectional view showing a magnetic recording medium according to an embodiment of the invention;

FIG. 2 is a cross-sectional view showing a magnetic recording medium according to another embodiment of the invention;

FIG. 3 is a cross-sectional view showing a principle of a magnetic disc device according to the invention;

FIG. 4 is a cross-sectional view of the magnetic disc device taken along a line B-B in FIG. 3;

FIG. 5 is a plan view showing a magnetic disc device according to an embodiment of the invention; and

FIG. 6 is a cross-sectional view of the magnetic disc device taken along a line A-A in FIG. 5.

### DESCRIPTION OF THE PREFERRED EMBODIMENTS

Hereinafter, preferred embodiments of the invention will be explained with reference to the accompanying drawings. Note that a magnetic disc will be demonstrated herein as a magnetic recording medium, and though the commercially available discs generally have a layer structure having a greater number of layers than the layer structure illustrated herein, the following explanation will be made on a magnetic disc having a simple layer structure to allow the invention to be more easily understood.

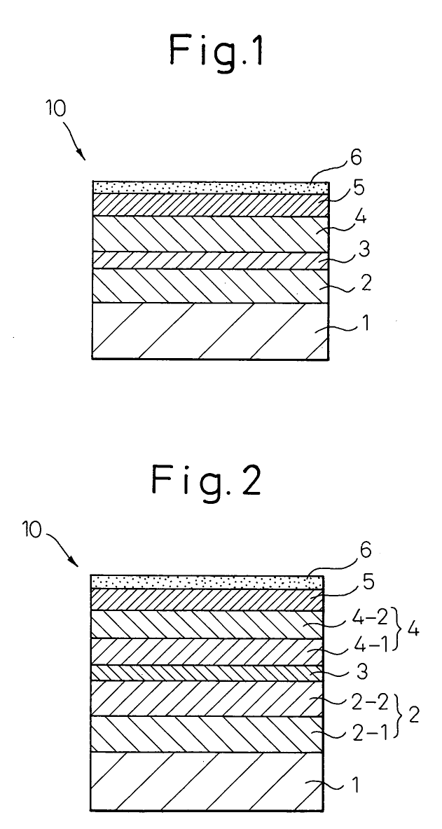

The magnetic recording medium according to the invention can basically have a layer structure that has generally been known and used as a magnetic recording medium. FIG. 1 shows a magnetic recording medium according to an embodiment of the invention. The magnetic recording medium 10 includes a non-magnetic substrate 1, an underlayer 2, an intermediate layer 3, a magnetic recording layer 4, a carbon protective layer 5 and a lubricant layer 6 as shown in this figure.

In the magnetic recording medium of the invention, the non-magnetic substrate is formed of various conventional materials used in this technical field. Suitable examples of the non-magnetic substrate include, but are not restricted to, an aluminum (inclusive of aluminum alloy) substrate coated with a NiP layer deposited by electroless plating, a glass or reinforced glass substrate, a silicon substrate having a surface oxide layer (such as a silicon oxide layer), an SiC substrate, a carbon substrate, a plastic substrate and a ceramic substrate. The surfaces of these substrates are preferably subjected to texture treatment. The texture treatment can be carried out by those methods which are generally used in this technical field. For example, it includes a method that concentrically conducts a mechanical or a laser texture treatment.

The underlayer is first disposed on the non-magnetic substrate. The underlayer is formed of ordinary non-magnetic metal materials in conventional magnetic media and is preferably formed of Cr or a Cr-based alloy (non-magnetic alloy containing chromium as a main component). The underlayer may have either a single layer as shown in FIG. 1 or a two-layered structure (underlayer 2 comprising lower layer 2-1 and upper layer 2-2) as shown in FIG. 2 that shows a magnetic recording medium according to another embodiment of the invention. Needless to say, the underlayer may have a multi-layered structure of three or more layers. In the case of the underlayer having the multi-layered structure, the composition of each layer can be arbitrarily changed. In the practice of the invention, it is recommended, in the underlayer having the multi-layered structure, that the constituent elements of the layers remain the same but their composition ratios (at %) be changed. This is because the technical meaning of the application of the underlayer having the multi-layered structure can be more improved by the different functions provided by each underlayer.

The underlayer is formed of Cr alone or a Cr-based alloy to which at least one kind of element selected from the group consisting of W, V, Ti and Mo is added. These underlayers have a bcc structure (body centered cubic structure). Suitable examples of materials of the underlayer include Cr, CrW, CrV, CrTi and CrMo.

The underlayer can be formed particularly advantageously of a CrMo alloy. When the magnetic recording layer of the magnetic recording medium contains platinum, for example, the underlayer is preferably formed of the CrMo alloy. In other words, because Mo is added, the lattice planar gap can be enlarged. When the lattice planar gap of the underlayer is brought close to the lattice planar gap of the magnetic recording layer that expands depending on the composition of the magnetic recording layer, particularly on the Pt amount, preferential orientation of the magnetic recording layer (CoCr-based alloy) into the plane of the C axis can be promoted.

The underlayer can be preferably formed by a sputtering method such as a magnetron sputtering method under the conventional film formation conditions. To improve coercive force, in particular, the sputtering method is preferably carried out under the application of a DC negative bias. The sputtering method according to the prior art uses an argon (Ar) gas as a film formation gas but, in the practice of the invention, sputtering must be carried out in the presence of a krypton (Kr) gas or a xenon (Xe) gas. These gases may be used in mixture, whenever necessary, or a third gas may be used as an assistant gas. In the suitable sputtering conditions, the layer formation or deposition temperature is from about 160 to about 270° C., a Kr or Xe gas pressure of about 0.2 to about 20 Pa and DC negative bias of about 100 to about 300 V.

The thickness of the underlayer can be changed in a broad range depending on various factors. To improve an S/N ratio, the thickness of the underlayer is generally within the range of 5 to 60 nm though this range is not restrictive. When the thickness of the underlayer is smaller than 5 nm, magnetic characteristics cannot be sufficiently exhibited in some cases and when the thickness is greater than 60 nm, on the contrary, noise is likely to increase.

The magnetic recording medium according to the invention may contain an additional underlayer formed of a metal material containing titanium (Ti) as a main component, preferably a Ti thin layer, between the non-magnetic substrate and the underlayer described above, whenever necessary. Such an additional underlayer has the function of further improving the bonding strength between the substrate and the underlayer.

In the magnetic recording medium of the invention, an intermediate layer is further sandwiched between the underlayer and the magnetic recording layer. The intermediate layer is preferably formed of a cobalt-based alloy containing at least one kind of element selected from the group consisting of Cr, Ta, Mo, Mn, Re and Ru that is added to cobalt (Co) as the main component, and has an hcp structure (close packed hexagonal structure).

Though the intermediate layer can be used at a variety of thickness, the thickness is generally and advantageously from about 0.5 to about 3.0 nm.

In the magnetic recording medium according to the invention, the magnetic recording layer can be basically constituted in the same way as a magnetic recording layer that is ordinary in the conventional magnetic recording media. The magnetic recording layer is particularly preferably formed of a CoCr-based alloy containing Co and Cr as the main components. Though the CoCr-based alloy has various compositions, preferred is a CoCr-based alloy containing Co as the main component and Cr as the assistant component and further containing arbitrarily an additional element or elements such as Pt, W, B, Ta, Bi, Nb and C, typically CoCrTa, CoCrPt, CoCrPtBi, CoCrPtWC and CoCrPtTaNb. An example of the useful CoCr-based alloy is a CoCr-based alloy expressed by the following formula.
CO_{bal.}—Cr₁₄₋₂₃—Pt₁₋₂₀—Wₓ—C_{y}

In the formula given above, the term “bal.” represents the balance and x+y is 1 to 7 at %. The noise can be drastically reduced by constituting the magnetic recording layer from the CoCrPt alloy, adding both of W and C and further optimizing the layer construction and the layer formation process. Consequently, a large S/N ratio can be obtained and, hence, a high density recording medium can be accomplished.

Another example of the alloy is a CoCr-based alloy expressed by the following formula.
Co_{bal.}—Cr₁₃₋₂₁—Pt₁₋₂₀—Taₓ—Nb_{y}

In the formula given above, the term “bal.” represents the balance and x+y is 1 to 7 at %.

The magnetic recording layer may have a single layer as shown in FIG. 1 or may have a two-layered structure (magnetic recording layer 4 comprising lower layer 4-1 and upper layer 4-2) as shown in FIG. 2 illustrating another embodiment of the magnetic recording medium of the invention. Needless to say, the magnetic recording layer may have a multi-layered structure of three or more layers though this is not shown in the drawings. In the case of the magnetic recording layer having the multi-layered structure, the composition of each layer can be arbitrarily changed. It is recommended, in the practice of the invention, that the constituent elements of the layers remain the same but their composition ratios (at %) be changed. Technical effects originated from the existence of the magnetic recording layer can be much more improved by providing different functions in each of the magnetic recording layers through the application of the multi-layered structure. In the multi-layered structure, a non-magnetic intermediate layer formed of Cr, Ru or their alloys may be sandwiched between the magnetic recording layers. The existence of such a non-magnetic layer can improve the magnetic recording characteristics.

In the magnetic recording medium according to the invention, the magnetic recording layer can be formed at a variety of thicknesses. In the magnetic recording layer, a product (tBr) of its residual magnetic flux density (Br) and its layer thickness (t) is preferably within the range of 2.0 to 10.0 nTm in both single layered structure and multi-layered structure. As the magnetic recording layer of the invention attains lower tBr than the magnetic recording layer of the prior art, the magnetic recording layer is most suitable particularly for use in different magneto-resistance effect-type heads including an MR head.

The magnetic recording layer deposited on the non-magnetic substrate through the underlayer can be formed by various methods but can be formed preferably by a sputtering method under specific layer formation conditions. To particularly improve the coercive force, the sputtering method is preferably carried out under the application of a DC negative bias. A magnetron sputtering method, for example, can be used as the sputtering method in the same way as in the layer formation of the underlayer and the intermediate layer described above. For the suitable layer formation conditions, the layer formation or deposition temperature is about 100 to 300° C., an Ar gas pressure is about 0.3 to about 20 Pa and a DC negative bias is about 80 to about 400 V. A deposition temperature exceeding about 300° C. may invite magnetism in the substrate that should originally be non-magnetic. Therefore, it is preferred that the use of such a high temperature is avoided. Other layer formation methods such as vacuum deposition, ion beam sputtering, and so forth, may be used in place of the sputtering method, whenever necessary.

The magnetic recording medium according to the invention comprises a protective carbon layer on the magnetic recording layer to protect the magnetic recording layer. The protective carbon layer may be a protective carbon layer of the prior art that has been generally used in the field of the magnetic recording media. The protective carbon layer is formed by using sputtering, chemical vapor deposition (CVD), FCA, and so forth. To impart improved durability to the resulting protective carbon layer, hydrogen and nitrogen may be added to the protective carbon layer. When the FCA method is employed, a carbon layer having higher hardness and richer in a diamond component can be obtained than the sputtering method and the CVD method that are conventional in the formation of the prior art protective carbon layers. The protective carbon layer can be formed at a variety of thicknesses generally used in the magnetic recording medium. The thickness of the protective carbon layer is generally within the range of 0.5 to 10 nm.

The magnetic recording medium according to the invention may have additional layers conventional in this technical field, in addition to the essential layers and arbitrary layers described above, or the layers constituting the magnetic recording medium may be subjected to any chemical treatment. For example, a fluorocarbon type lubricant layer may be applied onto the protective carbon layer or any other lubrication treatment may be applied to the carbon layer. A suitable lubricant is a liquid and is easily available under the trade names of “Fomblin™” and “Krytox™”. Such a lubricant so functions as to prevent the trouble called “head crash” that occurs upon contact of the head and the medium and destroys the magnetic recording data and, moreover, reduces the force of friction of sliding between the head and the medium and extends extend service life of the medium. The thickness of the lubricant layer is generally from about 0.1 to about 0.5 nm.

The invention resides also in a method of producing the magnetic recording medium described above. As can be understood from the description given above, the production method according to the invention comprises depositing, in sequence, at least one underlayer formed of Cr or a Cr-based alloy, at least one intermediate layer formed of a Co-based alloy and at least one magnetic recording layer formed of a CoCr-based alloy onto a non-magnetic substrate, and in this method, the underlayer and/or the intermediate layer is formed by a sputtering method in the presence of a krypton gas and/or a xenon gas.

The method of the invention can be carried out in various embodiments.

For example, the underlayer can be formed advantageously of a Cr-based alloy containing Cr as the main component and at least one kind of element selected from the group consisting of W, V and Mo added to Cr.

The intermediate layer can be formed advantageously of a Co-based alloy containing Co as the main component and at least one kind of element selected from the group consisting of Cr, Ta, Mo, Mn, Re and Ru added to Co. The intermediate layer can be preferably formed at a thickness of about 0.5 to about 3.0 nm.

Further, to form the magnetic recording layer, the sputtering conditions are preferably controlled so that the product (tBr) of the residual magnetic flux density (Br) of the magnetic recording layer and its layer thickness (t) attains about 2.0 to about 10.0 nTm.

The magnetic recording layer is preferably formed as a composite magnetic recording layer having at least two layers each formed of a CoCr-based alloy having a different composition. In the case of such a composite magnetic recording layer, a non-magnetic layer is preferably sandwiched between the respective magnetic recording layers.

When the underlayer and the intermediate layer are formed by sputtering in the practice of the method of the invention, it is preferred to form the layers at about 160 to about 270° C., to further form a non-magnetic NiP layer on a non-magnetic substrate and to apply texture treatment to the surface of the non-magnetic substrate.

In addition, the invention resides in a magnetic disc device using the magnetic recording medium of the invention, besides the magnetic recording medium and its production method described above. In the magnetic disc device according to the invention, its construction is not particularly limited but basically includes a device having a recording head portion for recording information and a reproduction head portion for reproducing the information in the magnetic recording medium.

The magnetic head will be explained. With the recent progress of information processing technologies, the requirement for a higher density in a magnetic disc device used for an external storage device of computer has increased. In view of this trend, the use of a magneto-resistance effect type head using a magneto-resistance effect element, the electric resistance of which changes in accordance with the intensity of a magnetic field, that is, an MR head, has been recommended in place of the winding type inductive thin film magnetic head of the prior art. The MR head uses the magneto-resistance effect of the change of the electric resistance of a magnetic substance depending on an external magnetic field, to reproduction of signals on a recording medium and has the features in that it can provide by far greater reproduction output width than the conventional inductive thin film magnetic head, the inductance is small and a large S/N ratio can be expected. In addition to this MR head, the use of an AMR head utilizing an anisotropic magneto-resistance effect, a GMR head utilizing a giant magneto-resistance effect and a spin bulb GMR head as a practical type of the former has also been recommended. The magnetic recording medium according to the invention is particularly useful for the magnetic recording media used for such magnetic disc devices.

The magnetic disc device according to the invention can preferably use a composite type magnetic head including a magneto-resistance effect type reproduction head portion including a magneto-resistance effect type element and a conductor layer for supplying a sense current to the magneto-resistance effect type element, for reading out information from a magnetic recording medium, and an induction type recording head portion having a pair of magnetic poles formed by a thin film, for recording the information to the magnetic recording medium, both head portions being stacked with each other. The magneto-resistance effect type reproduction head can have various constructions known in this technical field. The reproduction head preferably includes the AMR head utilizing the anisotropic magneto-resistance effect and the GMR head (inclusive of the spin bulb GMR head, etc) utilizing the giant magneto-resistance effect. The conductor layer of the reproduction head portion can have various constructions but preferably includes the following constructions:

1. a construction in which a portion of the conductor layer near the magneto-resistance effect type element is relatively thin while the other portions are thick; and

2. a construction in which a portion of the conductor layer near the magneto-resistance effect type element is relatively thin and narrow while the other portions are thick and wide.

The thickness and the width, whenever necessary, of the conductor layer can be adjusted as described above by various methods but it is particularly recommended to increase the thickness by forming the conductor layer as a multi-layered structure.

When the composite type magnetic head assembled into the magnetic disc device having the construction described above, in particular, is employed, it becomes possible to reduce the curve of the magnetic poles of the recording head portion, to lower the resistance of the conductor layer and to read out the information correctly and at a high sensitivity within a small off-track range in comparison with the composite type magnetic head of the prior art.

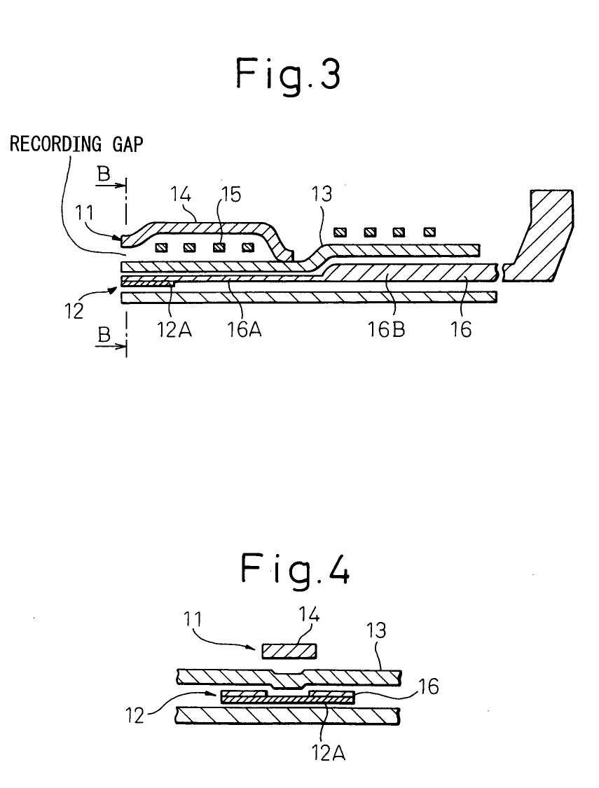

In the composite type magnetic head to be assembled into the magnetic disc device according to the invention, the recording head portion and the reproduction head portion can preferably employ the stacked structure as shown in FIGS. 3 and 4. FIG. 3 is a view showing the principle of the composite type magnetic head assembled into the magnetic disc device according to the invention and FIG. 4 is a cross-sectional view taken along a line B-B of FIG. 3.

In FIGS. 3 and 4, reference numeral 11 denotes an induction type recording head portion for recording information to a magnetic recording medium. Reference numeral 12 denotes a magneto-resistance effect type reproduction head portion for reading out the information. The recording head portion 11 includes a lower magnetic pole (upper shield layer) 13 formed of NiFe, etc, an upper magnetic pole 14 formed of NiFe, etc, and facing the lower magnetic pole 13 with a predetermined gap and a coil 15 for exciting these magnetic poles 13 and 14 and recording the information to the magnetic recording medium at the recording gap portion.

The reproduction head portion 12 is preferably formed of an AMR head or a GMR head. A pair of conductor layers 16 for supplying a sense current to the magneto-resistance effect element portion 12A is disposed on the magneto-resistance effect element portion 12A with a gap between them that corresponds to the recording track width. Here, the conductor layers 16 is formed to be thin at a portion 16A of the magneto-resistance effect element portion 12A and to be thick at other portions 16B.

In the construction shown in FIGS. 3 and 4, because the thickness of the conductor layer 16 is small at the portion 16A near to the magneto-resistance effect element portion 12A, the curve of the lower magnetic pole (upper shield layer) 13 is small. Therefore, the shape of the recording gap facing the magnetic recording medium is not very curved, either. Even when a positioning error of the position of the magnetic head on the track exists to a certain extent between recording and reproduction of the information, the magnetic disc device can correctly read out the information and the problem of a read error can be avoided even though the off-track amount is small.

On the other hand, because the conductor layer 16 is formed in such a manner that its thickness is large at the portions 16B other than the portion in the proximity of the magneto-resistance effect element portion 12A, the resistance of the conductor layer 16 can be decreased as a whole. As a result, the resistance change of the magneto-resistance element portion 12A can be detected with a high sensitivity, the S/N ratio can be improved, exothermy at the conductor layer 16 can be avoided and the occurrence of noise resulting from exothermy can be prevented.

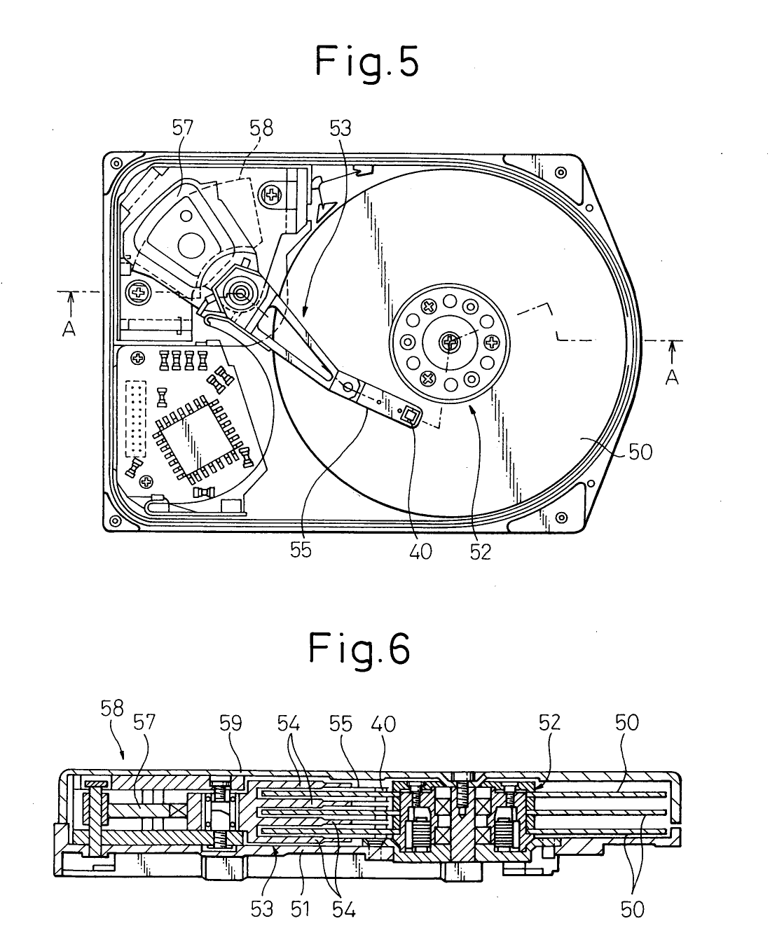

FIGS. 5 and 6 show a preferred example of the magnetic disc device according to the invention. Incidentally, FIG. 5 is a plan view of the magnetic disc device (from which a cover was removed) and FIG. 6 is a cross-sectional view taken along a line A-A of FIG. 5.

In these drawings, reference numeral 50 denotes a plurality (three, in the drawings) of magnetic discs as a magnetic recording medium driven for rotation by a spindle motor 52 arranged on a base plate 51.

Reference numeral 53 denotes an actuator disposed on the base plate 51 in such a manner as to be capable of rotation. A plurality of head arms 54 extending in the direction of the recording surface of the magnetic disc 50 is formed at one of the rotary end portions of the actuator 53. A spring arm 55 is fitted to the rotary end portion of each head arm 54 and a slider 40 is fitted to a flexure portion of the spring arm 55 through an insulating film, not shown, in such a fashion as to be capable of inclination. On the other hand, a coil 57 is disposed at the other rotary end portion of the actuator 53.

A magnetic circuit 58 constituted by a magnet and a yoke is arranged on the base plate 51. The coil 57 described above is disposed inside a magnetic gap of this magnetic circuit 58. The magnetic circuit 58 and the coil 57 together constitute a moving coil type linear motor (VCM: Voice Coil Motor). A cover 59 covers the upper portion of the base plate 51.

Next, the operation of the magnetic disc device having the constitution described above will be explained. The slider 40 keeps contact with a standby zone of the magnetic disc 50 and is halted while the magnetic disc 50 is halted.

Next, when the spindle motor 52 drives and rotates at a high speed the magnetic disc 50, the slider 40 flies above the disc surface with a small gap due to the air stream generated by the rotation of this magnetic disc 50. When a current is caused to flow through the coil 57 under this state, dynamic lift develops in the coil 57 and the actuator 53 starts rotating. In consequence, it becomes possible to move the head (slider 40) onto a desired track of the magnetic disc 50 and to read or write the data.

Since the conductor layer of the magnetic head in which the portion in the proximity of the magneto-resistance effect element portion is thin, and other portions are thick, is used in this magnetic disc device, the curve of the magnetic poles of the recording head portion can be made small, the resistance of the conductor layer can be lowered and the information can be read out correctly and with a high sensitivity within the range in which off-track is small.

### EXAMPLES

The following examples are intended to further explain the present invention.

### Example 1

In this example, the magnetic disc schematically shown in FIG. 2 was produced. A layer construction of the magnetic disc 10 includes an aluminum substrate 1 plated with NiP coating, and a Cr underlayer (lower layer) 2-1, a CrMo₂₅ underlayer (upper layer) 2-2, a CoCr₁₃Ya₅ intermediate layer 3, a CoCr₂₄Pt₁₂B₄ magnetic recording layer (lower layer) 4-1, a CoCr₂₄Pt₁₀B₆ magnetic recording layer 4-2 (upper layer), a protective carbon layer (DLC) 5 and a lubricant layer 6 deposited in this order on the substrate 1.

First, NiP was deposited on an aluminum (Al) substrate by electroless plating to form a NiP plating layer. The surface was sufficiently washed and subjected to a texture treatment to sufficiently planarize the surface. The texture treatment was carried out by concentrically applying a mechanical texture to the substrate surface.

Next, a Cr underlayer and a CrMo₂₅ (at %) underlayer were deposited in this order through sputtering on the resulting NiP/Al substrate by using a DC magnetron sputtering apparatus. In this example, a Kr gas was introduced into a sputtering chamber during sputtering in place of an Ar gas that is generally used. To conduct sputtering, the degree of vacuum inside the sputtering chamber was evacuated to 1×10⁻⁵ Pa or below and the vacuum was held at 0.67 Pa inside the sputtering chamber during layer deposition.

The Cr underlayer was deposited for orienting the magnetic recording layer (CoCrPtB alloy) in an in-plane direction. Before this underlayer was formed, it was necessary to clean impurities adhering to the substrate surface and to raise the substrate temperature to about 200° C. or more so as to control crystal orientation performance of Cr. However, as magnetization of NiP due to crystallization occurs when the temperature exceeds 270° C., the layer formation temperature must generally be within the range of about 200 to about 270° C. In this example, the substrate temperature before the formation of the underlayer was set to 220° C. and the Cr underlayer was deposited at a thickness of 5 nm.

Subsequently, a CrMo-based alloy having a greater lattice constant than Cr was deposited on the Cr underlayer under the same sputtering conditions as described above. The formation of the CrMo underlayer provides matching of the planar gaps of the crystal lattice with the magnetic recording layer and thus satisfactory in-plane orientation is obtained. The thickness of the CrMo underlayer so obtained was 2 nm.

After the formation of the underlayer having the two-layered structure was completed in the manner described above, an intermediate CoCr₁₃Ta₅ layer (at %) was deposited by sputtering. The sputtering conditions were the same as those of the underlayer described above, and the Kr gas was introduced into the sputtering chamber in place of the Ar gas that is ordinarily used. Incidentally, the CoCrTa alloy hereby used as the material of the intermediate layer has an hcp structure and crystal orientation performance into the plane of the magnetic recording layer is excellent. The thickness of the resulting CoCrTa intermediate layer was 1 nm.

Thereafter, the layers of the CoCr₂₄Pt₁₂B₄ alloy (at %) and the CoCr₂₀Pt₁₀B₆ alloy (at %) were deposited in this order by sputtering to form a magnetic recording layer having the two-layered structure. The sputtering conditions were the same as those of the underlayer and the intermediate layer described above but, in this step, the Ar gas used ordinarily for sputtering was introduced into the sputtering chamber. The total thickness tBr (product of residual magnetization and layer thickness) of the resulting magnetic recording layer was 5.0 nTm.

After the CoCrPtB magnetic recording layer of the upper layer is formed, a DLC protective film is further formed on the former to a film thickness of 4 nm, and a lubricant layer formed of “Fomblin” (trade name) is impregnated.

Magnetic performance (tBr: product of residual magnetization and layer thickness, Hc: coercive force, S: squareness ratio, S*: coercive force squareness ratio) of the resulting magnetic disc was measured to obtain the measurement results summarized in Table 1.

### Example 2

The procedure described in Example 1 was repeated with the exception that the gas introduced into the sputter chamber for forming the underlayers and the intermediate layer was changed from the Kr gas to a Xe gas (Example of the Invention) or to the Ar gas (Comparative Example) and the gas introduced for forming the magnetic recording layer was changed from the Ar gas to the Kr gas or to the Xe gas.

Magnetic performance (tBr: product of residual magnetization and layer thickness, Hc: coercive force, S: squareness ratio, S*: coercive force squareness ratio) of the resulting magnetic disc was measured to obtain the measurement results summarized in Table 1.

TABLE 1

| | Layer | Magnetic Characteristics | | | |
|---|---|---|---|---|---|
| Deposited | forming | tBr | | | |
| Layer | Gas | (nTm) | Hc (Oe) | S | S* |
| Cr Underlayer | Ar | 5.2 | 3227 | 0.91 | 0.75 |
| | Kr | 5.1 | 3391 | 0.86 | 0.75 |
| | Xe | 5.1 | 3372 | 0.84 | 0.76 |
| CoCrTa | Ar | 5.2 | 3227 | 0.91 | 0.75 |
| Intermediate | Kr | 5.3 | 3430 | 0.93 | 0.77 |
| Layer | Xe | 5.2 | 3320 | 0.85 | 0.77 |
| CoCrPtB | Ar | 5.2 | 3227 | 0.91 | 0.75 |
| Magnetic | Kr | 4.9 | 2899 | 0.89 | 0.70 |
| Recording | Xe | 4.9 | 2579 | 0.93 | 0.69 |
| Layer | | | | | |
| All Layers | Ar | 5.2 | 3227 | 0.91 | 0.75 |
| | Kr | 4.9 | 2981 | 0.92 | 0.72 |
| | Xe | 4.9 | 2571 | 0.94 | 0.69 |

It can be seen from the measurement results in Table 1 that the recording medium using the Kr or Xe gas for the formation of the underlayer and the intermediate layer has higher thermal disturbance resistance than the media produced by using the Ar gas that has been conventionally used in the prior art methods.

1. A magnetic recording medium comprising a non-magnetic substrate having deposited thereon, in sequence, at least one underlayer formed of Cr or a Cr-based alloy, at least one intermediate layer formed of a Co-based alloy and at least one magnetic recording layer formed of a CoCr-based alloy, wherein the underlayer and/or the intermediate layer is a thin film formed by a sputtering method in the presence of krypton gas and/or xenon gas.

2. A magnetic recording medium as defined in claim 1, wherein the underlayer comprises a Cr-based alloy comprising Cr as a main component and at least one kind of element selected from the group consisting of W, V and Mo added to Cr, and has a bcc structure (body centered cubic structure).

3. A magnetic recording medium as defined in claim 1, wherein the intermediate layer is formed of a Co-based alloy comprising Co as a main component and at least one kind of element selected from the group consisting of Cr, Ta, Mo, Mn, Re and Ru added to Co, and has an hcp structure (close packed hexagonal structure).

4. A magnetic recording medium as defined in claim 1, wherein the intermediate layer has a thickness of 0.5 to 3.0 nm.

5. A magnetic recording medium as defined in claim 1, wherein a product (tBr) of a residual magnetic flux density (Br) of the magnetic recording layer and its layer thickness (t) is from 2.0 to 10.0 nTm.

6. A magnetic recording medium as defined in claim 1, wherein the magnetic recording layer is a composite magnetic recording layer having at least two layers each formed of a CoCr-based alloy having a different composition.

7. A magnetic recording medium as defined in claim 6, wherein a non-magnetic layer is sandwiched between adjacent magnetic recording layers of the composite magnetic recording layer.

8. A magnetic recording medium as defined in claim 7, wherein the non-magnetic layer is formed of Cr, Ru or their alloy.

9. A magnetic recording medium as defined in claim 1, wherein the underlayer and/or the intermediate layer each is formed at a temperature of 160 to 270° C.

10. A method of producing a magnetic recording medium comprising a non-magnetic substrate having a magnetic recording layer applied thereon, comprising:
depositing, in sequence, at least one underlayer formed of Cr or a Cr-based alloy, at least one intermediate layer formed of a Co-based alloy and at least one magnetic recording layer formed of a CoCr-based alloy onto the non-magnetic substrate; and in which method
the underlayer and/or the intermediate layer is formed by a sputtering method in the presence of a krypton gas and/or a xenon gas, respectively.

11. A method of producing a magnetic recording medium as defined in claim 10, wherein the underlayer is formed of a Cr-based alloy comprising Cr as a main component and at least one kind of element selected from the group consisting of W, V and Mo added to Cr.

12. A method of producing a magnetic recording medium as defined in claim 10, wherein the intermediate layer is formed of a Co-based alloy comprising Co as a main component and at least one kind of element selected from the group consisting of Cr, Ta, Mo, Mn, Re and Ru added to Co.

13. A method of producing a magnetic recording medium as defined in claim 10, wherein the intermediate layer is formed at a thickness of 0.5 to 3.0 nm.

14. A method of producing a magnetic recording medium as defined in claim 10, wherein the sputtering condition is controlled so that a product (tBr) of a residual magnetic flux density (Br) of the magnetic recording layer and its layer thickness (t) is from 2.0 to 10.0 nTm in the film formation of the magnetic recording layer.

15. A method of producing a magnetic recording medium as defined in claim 10, wherein the magnetic recording layer is formed into a composite magnetic recording layer having at least two layers each formed of a CoCr-based alloy having a different composition.

16. A method of producing a magnetic recording medium as defined in claim 15, wherein a non-magnetic layer is further sandwiched between respective magnetic recording layers of the composite magnetic recording layer.

17. A method of producing a magnetic recording medium as defined in claim 16, wherein the non-magnetic layer is formed of Cr, Ru or their alloy.

18. A method of producing a magnetic recording medium as defined in claim 16, wherein the underlayer and/or the intermediate layer each is formed at a temperature of 150 to 270° C.

19. A magnetic disc device having a recording head for recording information and a reproduction head for reproducing information in a magnetic recording medium, wherein the magnetic recording medium is a magnetic recording medium as described in claim 1.
